(19) United States
(12) Patent Application Publication
(10) Pub. No.: US 2017/0087984 A1
(43) Pub. Date: Mar. 30, 2017

(54) TANDEM AXLE GEARING ARRANGEMENT TO REDUCE DRIVE PINION BEARING PARASITIC LOSSES

(71) Applicant: Dana Heavy Vehicle Systems Group, LLC, Maumee, OH (US)

(72) Inventors: Andrew L. Nieman, Lambertville, MI (US); Steven G. Slesinski, Ann Arbor, MI (US); Harry W. Trost, Royal Oak, MI (US)

(21) Appl. No.: 15/273,768

(22) Filed: Sep. 23, 2016

Related U.S. Application Data
(60) Provisional application No. 62/233,824, filed on Sep. 28, 2015.

(51) Int. Cl. B60K 17/36; F16H 37/08; B60K 17/346; F16H 48/08

(52) U.S. Cl. CPC B60K 17/36; F16H 48/08; F16H 37/0813; B60K 17/346

(57) ABSTRACT

The present disclosure relates to a gearing arrangement for a tandem axle assembly for a vehicle that reduces parasitic losses associated with the bearings of a drive pinion. The gearing arrangement includes a first helical gear in driving engagement with an input shaft and a portion of an interaxle differential; a second helical gear coupled to a pinion shaft with at least two bearings mounted on either side of the second helical gear on the pinion shaft; and a drive pinion coupled to the pinion shaft and meshingly engaged with a ring gear. The ring gear is in driving engagement with a forward differential assembly. The first helical gear and second helical gear are meshingly engaged and have a predetermined gear ratio.

### CROSS-REFERENCE TO RELATED APPLICATIONS

This application is claiming the benefit, under 35 U.S.C. 119(e), of the provisional application granted Ser. No. 62/233,824 filed on Sep. 28, 2015, the entire disclosure of which is hereby incorporated by reference.

### FIELD

The present disclosure relates to a gearing arrangement for a tandem axle assembly for a vehicle that reduces parasitic losses associated with the bearings of a drive pinion.

### BACKGROUND

Increases in fuel efficiency are becoming more important to owner and operators of vehicles, particularly large vehicles such as tandem axle tractor trailers. Every aspect of the vehicle driveline is undergoing scrutiny to determine where parasitic losses can be reduced or eliminated so that fuel efficiency can be improved.

One structure that has received attention to determine if losses can be reduced or eliminated is the bearings in the vehicle driveline. More particularly, the bearings that support pinion shafts appear to create an inordinate amount of drag as they rotate through lubricant. The parasitic power losses of the bearings is a function of speed due to the amount of parasitic fluid drag resulting from rotating through the lubricant. The slower the axle gear ratio (i.e. the higher numerically) the faster the pinion gear must rotate for a given vehicle speed. Power consumption is a function of the multiplication of torque and rotational speed. Thus, the pinion bearings consume more power the slower the axle gear ratio because the bearings rotate at a faster speed.

Therefore, it would be advantageous to find a way to reduce the parasitic power losses created by the bearings to increase the vehicle driveline efficiency.

### SUMMARY

A gearing arrangement for a tandem axle system of a vehicle including a first helical gear in driving engagement with an input shaft and a portion of an interaxle differential; a second helical gear coupled to a pinion shaft with at least two bearings mounted on either side of the second helical gear on the pinion shaft; and a drive pinion coupled to the pinion shaft and meshingly engaged with a ring gear. The ring gear is in driving engagement with a forward differential assembly. The first helical gear and second helical gear are meshingly engaged and have a predetermined gear ratio.

### BRIEF DESCRIPTION OF THE DRAWINGS

The above, as well as other advantages of the present embodiments, will become readily apparent to those skilled in the art from the following detailed description when considered in the light of the accompanying drawings in which:

FIG. 1 is a schematic perspective view of a preferred embodiment of a tandem axle assembly in accordance with the present disclosure;

FIG. 2 is a detailed cutaway side view of one embodiment of a forward axle system of the tandem axle assembly of FIG. 1;

FIG. 3 is a cutaway schematic side view of one embodiment of a forward axle system of the tandem axle assembly of FIG. 1;

FIG. 4 is a partial, schematic cutaway top view of the forward axle system depicted in FIG. 3; and

FIG. 5 is a cutaway schematic side view of one embodiment of a rear axle system of the tandem axle assembly of FIG. 1.

### DETAILED DESCRIPTION OF THE PREFERRED EMBODIMENTS

It is to be understood that the embodiments may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments

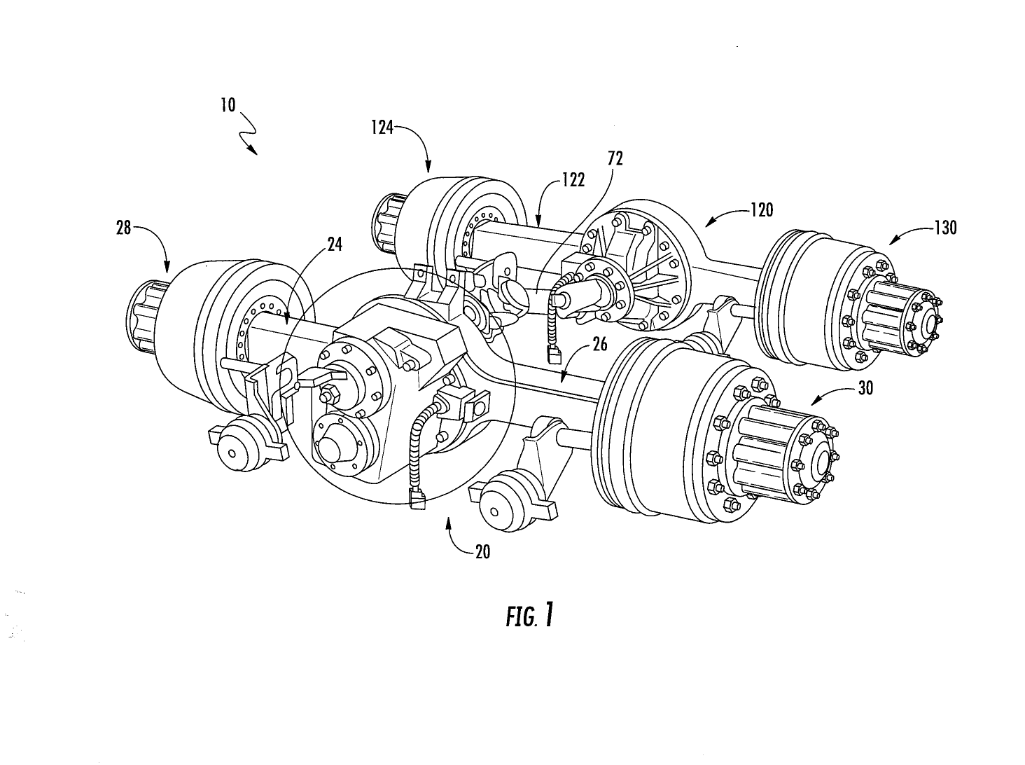

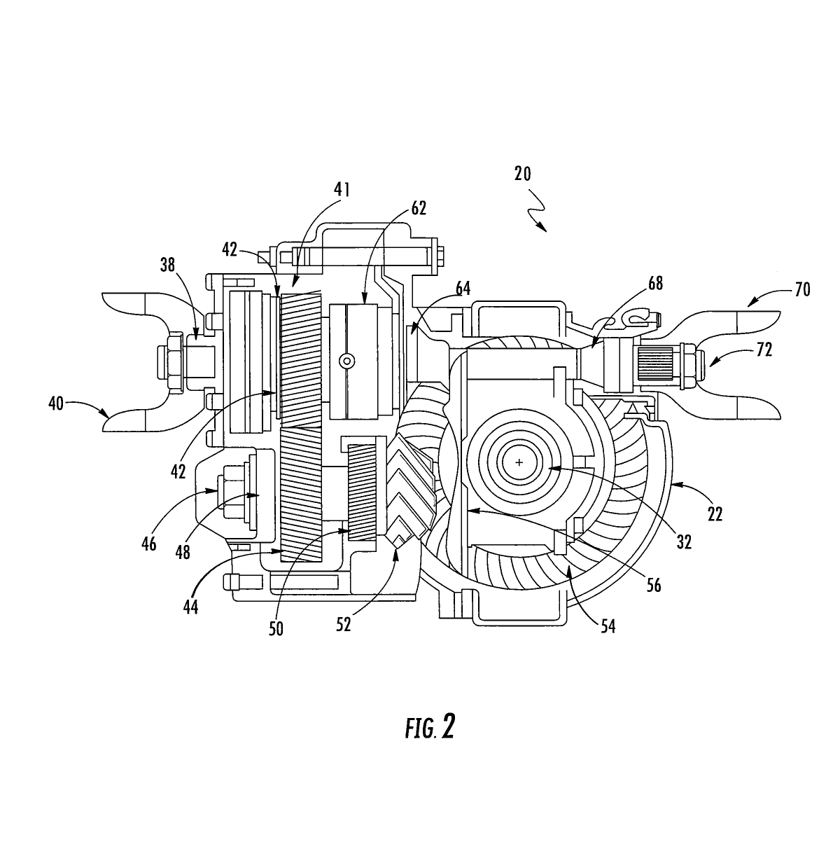

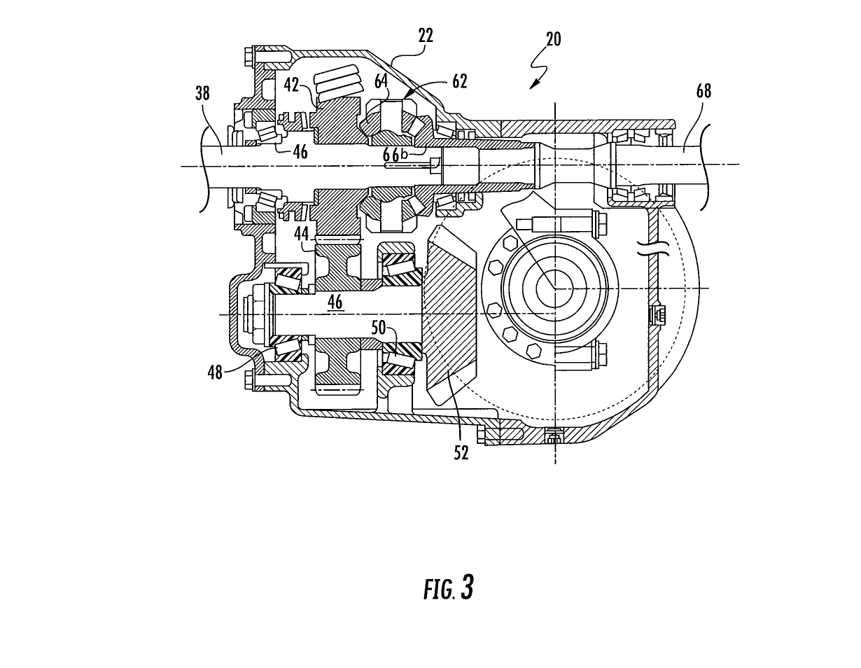

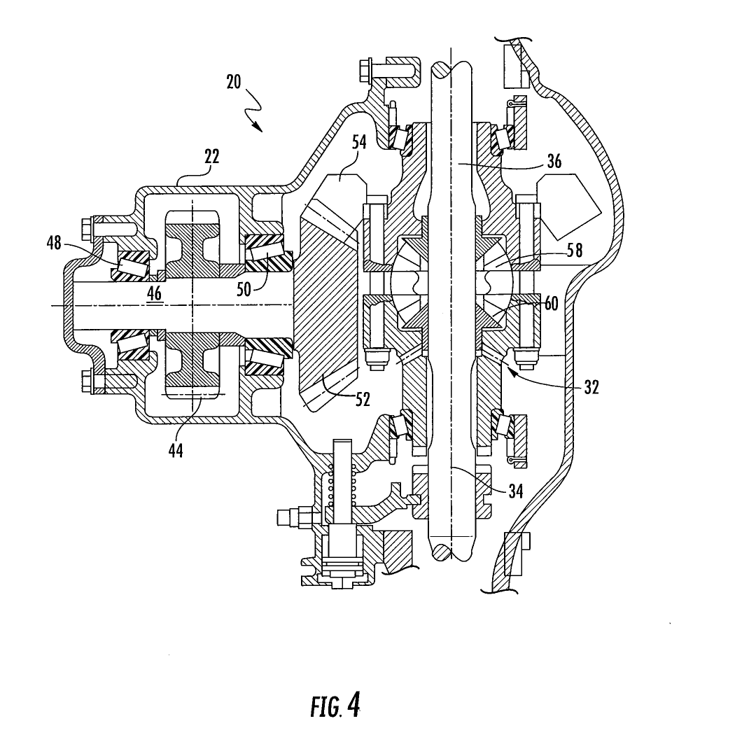

As depicted in FIGS. 1-4, one embodiment of a tandem axle assembly 10 for a vehicle includes a forward axle system 20 and a rear axle system 120. The forward axle system 20 has a housing 22. The housing 22 maybe hollow and has integrally formed first arm 24 and second arm 26 extending therefrom. The housing 22 may be of one-piece construction or multi-piece construction. A first wheel hub 28 is rotatably mounted at the end of the first arm 24 and a second wheel hub 30 is rotabably mounted at the end of the second arm 26. Wheels and tires (neither shown) are mounted on the wheel hubs 28, 30.

A forward differential assembly 32 is located within the housing 22. A first axle half shaft 34 is connected to the forward differential assembly 32. The first axle half shaft 34 extends from the forward differential assembly 32 to the first wheel hub 28 within the first arm 24. A second axle half shaft 36 is connected to the forward differential assembly 32. The second axle half shaft 36 extends from the forward differential assembly 32 to the second wheel hub 30 within the second arm 26. Rotational power from the forward differential assembly 32 is transmitted through the axle half shafts 34, 36 to the wheel ends to cause the vehicle to move over the road.

In the depicted embodiment, rotational power is provided to the forward differential assembly 32 from an engine and/or transmission (not shown). The rotational power is provided to the forward differential assembly 32 through an input shaft 38. A yoke 40 may be connected to the input shaft 38 for connecting with a complementary yoke (not shown).

The input shaft 38 extends into a hollow interior of the housing 22. The input shaft 38 is connected to a gearing arrangement 41. The gearing arrangement 41 includes a first helical gear 42. The first helical gear 42 is coaxial with the input shaft 38. The first helical gear 42 is directly meshed with a second helical gear 44. The second helical gear 44 is located below the first helical gear 42 in the housing 22. The second helical gear 44 is located on a pinion shaft 46 that is parallel but not coaxial with the input shaft 38. The pinion shaft 46 is mounted for rotation within the housing 22 on a first bearing 48 and a second bearing 50. The bearings 48, 50 are positioned on either side of the second helical gear 44 on the pinion shaft 46.

A drive pinion 52 is mounted on the pinion shaft 46. The drive pinion 52 is directly connected to a ring gear 54. In one embodiment, the drive pinion 52 and ring gear 54 have a gear ratio of 2.26. The drive pinion 52 permits the input shaft 38 to be mounted lower in the housing 22 resulting in a vertically compressed forward drive axle system 20. The ring gear 54 is directly connected to the forward differential assembly 32. The forward differential assembly 32 includes a differential case 56 that houses at least one pinion gear 58 and at least one side gear 60. Preferably, the differential case 56 houses two pinion gears 58 mounted on a spider shaft (not depicted) where the spider shaft extends into the differential case 56. The pinion gears are directly meshed with at least two side gears 60. The side gears 60 have hollow interiors bounded by splines. The splines mesh with splines on the first and second axle half shafts 34, 36. The forward differential assembly 32 divides rotational drive from the ring gear 54 to the first axle half shaft 34 and the second axle half shaft 36.

The first helical gear 42 is drivingly connected to an interaxle differential 62. The interaxle differential 62 may be comprised of at least one pinon gear 64 and at least one side gear 66. Preferably, the interaxle differential 62 includes two pinion gears 64 meshed with a first side gear 66a and a second side gear 66b. The interaxle differential 62 divides rotational drive from the input shaft 38 between the first helical gear 42 and the first side gear 66a.

An output shaft 68 is connected to the second side gear 66b. The output shaft 68 is co-axial with the input shaft 38 and is mounted for rotation in the housing 22. The output shaft 68 extends over differential case 56 and the axle half shafts 34, 36. The output shaft 68 extends axially through the rear of the housing 22. A yoke 70 may be connected to the output shaft 68. The yoke 70 may be connected to a prop shaft 72. In one embodiment, the side gear 66b is connected to the output shaft 68 to drive prop shaft 72.

The first helical gear 42 rotates at the same speed at the input shaft 38 since the two are directly connected to one another without any structure between them to increase or decrease the rotation. If the first and second helical gears 42, 44 in a tandem axle assembly have a 1:1 gear ratio, the drive pinion 52 turns at the same speed as the input shaft 38. However, by intentionally under-driving the drive pinion 52 by adjusting the gear ratio of the helical gears 42, 44, the rotational speed of the drive pinion 52 can be reduced. In one embodiment, the helical gears 42, 44 may be designed to have a 1.57 gear ratio. Because the parasitic power loss of the bearings 48, 50 is a function of speed, decreasing the speed of the drive pinion 52 increases drive line efficiency. The gear ratios provided in the forward axle system 20 may be selected based on the desired needs and efficiency of the vehicle. Helical gears 42, 44 each have tooth inclination, i.e., the teeth are disposed at an angle relative to the axes of the gears 42, 44. The desired gear ratio for the first and second helical gears 42, 44 can be achieved by providing helical gears 42, 44 with different outer diameters or by varying the number of teeth on each gear. The speed of the helical gears 42, 44 are inversely proportional to the ratio of their outer diameters and to the ratio of the number of gear teeth. In one preferred embodiment, the number of teeth on the first helical gear 42 is less than the number of teeth on the second helical gear 44. Additionally or alternatively, the first helical gear 42 can have an outer diameter smaller than the outer diameter of the second helical gear 44.

If the number of teeth and/or the outer diameter between the helical gears 42, 44 differs, it results in the second helical gear 44 rotating at a different speed than the first helical gear 42. In one preferred embodiment, the second helical gear 44 rotates slower than the first helical gear 42. The helical gears 42, 44 in the forward axle system 20 result in the drive pinion 52 driving the ring gear 54 at a predetermined drive ratio. The result of rotating the second helical gear 44 slower than the first helical gear 42 is that the drive pinion 52 connected to the drive shaft 46 rotates slower than the input shaft 38.

In another embodiment, the second helical gear 44 rotates faster than the first helical gear 42, i.e. the drive pinion 52 is over-driven. The result of rotating the second helical gear 44 faster than the first helical gear 42 is that the drive pinion 52 connected to the drive shaft 46 rotates faster than the input shaft 38.

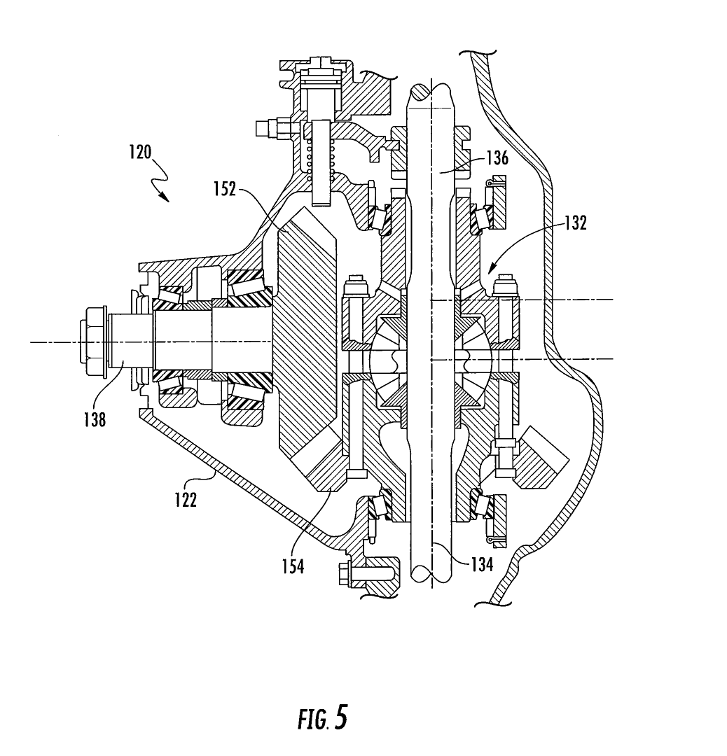

As shown in FIGS. 1 and 5, the prop shaft 72 extends from the forward axle system 20 to the rear axle system 120. The prop shaft is connected to an input shaft 138 of the rear axle system 120. The rear axle system 120 has a housing 122. The housing 122 may be of one-piece construction or multi-piece construction. The input shaft 138 is rotatingly mounted within the housing 122. The housing 122 has integrally formed first 124 and second arm 126 extending therefrom. A first wheel hub 128 is rotatably mounted at the end of the first arm 124 and a second wheel hub 130 is rotabably mounted at the end of the second arm 126. Wheels and tires (neither shown) are mounted on the wheel hubs 128, 130.

A drive pinion 152 is located on the end of the input shaft 138. The drive pinion 152 is co-axial with the input shaft 138. The drive pinion 152 is engaged with a ring gear 154. The ring gear 154 is connected to a rear differential assembly 132. The rear differential assembly 132 is located within the housing 122. A first axle half shaft 134 is connected to the rear differential assembly 132. The first axle half shaft 134 extends from the rear differential assembly 132 to the first wheel hub 128 within the hollow first arm 124. A second axle half shaft 136 is connected to the rear differential assembly 132. The second axle half shaft 136 extends from the rear differential assembly 132 to the second wheel hub 130 within the hollow second arm 126. Rotational power from the rear differential assembly 132 is transmitted through the axle half shafts 134, 136 to the wheel ends to cause the vehicle to move over the road. The rear differential assembly 132 divides the rotational drive provided by the ring gear 154 between a first rear axle half shaft 134 and a second rear axle half shaft 136.

The ring gear 154 is directly connected to a differential 156. The rear differential assembly 132 includes a differential case (not pictured) that houses at least one pinon gear (not depicted) and at least one side gear (not depicted). Preferably, the differential case houses two pinion gears mounted on a spider shaft (not depicted) where the spider shaft extends into the differential case. The pinion gears are directly meshed with at least two side gears (not depicted). The side gears have hollow interiors bounded by splines. The splines mesh with splines on the first and second axle half shafts 134, 136.

The first and second forward axle half shafts 34, 36 and the first and second rear axle half shafts 134, 136 each are located within their respective half shaft housings and extend away from their respective differentials 56, 156.

The gear ratios provided in the forward and rear tandem axles systems 20, 120 may be selected based on the desired needs and efficiency of the vehicle. In one embodiment, the drive pinion 152 driving the ring gear 154 in the rear axle system 120 is not reduced as it is in the front axle system 20. In one embodiment, the drive ratio for the rear axle system 120 may be, but is not limited to, 3.55. Thus, the drive ratio for the pinion 52 and ring gear 54 for the forward axle system 20 is different, more particularly reduced, compared to the drive ratio for the pinion 152 and ring gear 154 for the rear axle system 120.

In accordance with the provisions of the patent statutes, the present invention has been described in what is considered to represent its preferred embodiments. However, it should be noted that the embodiments can be practiced otherwise than as specifically illustrated and described without departing from its spirit or scope.

We claim:

1. A gearing arrangement for a tandem axle system of a vehicle, comprising:
a first helical gear in driving engagement with an input shaft and a portion of an interaxle differential;
a second helical gear coupled to a pinion shaft with at least two bearings mounted on either side of the second helical gear on the pinion shaft; and
a drive pinion coupled to the pinion shaft and meshingly engaged with a ring gear;
wherein the ring gear is in driving engagement with a forward differential assembly, and
wherein the first helical gear and second helical gear are meshingly engaged and have a predetermined gear ratio.

2. The gearing arrangement of claim 1, wherein the first and second helical gears have teeth thereon wherein the number of teeth on the first helical gear is less than the number of teeth on the second helical gear.

3. The gearing arrangement of claim 1, wherein the first helical gear has an outer diameter, the second helical gear has an outer dimeter and the outer diameter of the first helical gear is smaller than the outer diameter of the second helical gear.

4. The gearing arrangement of claim 1, wherein the drive pinion rotates slower than the input shaft.

5. The gearing arrangement of claim 1, wherein the gearing arrangement is part of a forward axle system.

6. The gearing arrangement of claim 1, wherein the first helical gear is coaxial with the input shaft and the second helical gear is coaxial with the pinion shaft.

7. The gearing arrangement of claim 1, wherein the pinion shaft is parallel to the input shaft and mounted for rotation in a housing.

8. The gearing arrangement of claim 7, wherein the second helical gear is located below the first helical gear in the housing.

9. The gearing arrangement of claim 1, wherein the first and second helical gears have a gear ratio of 1.57.

10. The gearing arrangement of claim 1, wherein the gear ratio of the drive pinion and ring gear is 2.26.

11. The gearing arrangement of claim 5, wherein the gearing arrangement further comprises an output shaft drivingly connected to the interaxle differential and a rear axle system.

12. The gearing arrangement of claim 11, wherein the output shaft is co-axial with the input shaft.

13. The gearing arrangement of claim 11, wherein the rear axle system comprises an input shaft drivingly connected to the output shaft; a drive pinion drivingly connected to the input shaft of the rear axle system; a ring gear engaged with the pinion gear of the rear axle system and a rear differential drivingly connected to the rear ring gear of the rear axle system.

14. The gearing arrangement of claim 13, wherein the rear axle system drive pinion and ring gear have a gear ratio different than the gear ratio of the forward axle system drive pinion and ring gear.
